(19) United States
(12) Patent Application Publication
(10) Pub. No.: US 2026/0106430 A1
(43) Pub. Date: Apr. 16, 2026

(54) PHOTONIC INTEGRATED CIRCUIT COMPRISING GAIN MEDIUM, AND OPTOELECTRONIC DEVICE

(71) Applicant: ams-OSRAM International GmbH, Regensburg (DE)

(72) Inventors: Joerg Erich SORG, Regensburg (DE); Norwin VON MALM, Thumhausen/Nittendorf (DE); Johann RAMCHEN, Hausen (DE)

(73) Assignee: ams-OSRAM International GmbH, Regensburg (DE)

(21) Appl. No.: 19/116,600

(22) PCT Filed: Sep. 18, 2023
(86) PCT No.: PCT/EP2023/075698

§ 371 Date: Mar. 28, 2025

(30) Foreign Application Priority Data
Sep. 30, 2022 (DE) 10 2022 125 325.2

(51) Int. Cl. H01S 3/16; H01S 3/0941

(52) U.S. Cl. CPC H01S 3/1603; H01S 3/0941; H01S 3/163

(57) ABSTRACT

A photonic integrated circuit includes a pumping laser diode that is designed to emit pumping radiation The photonic integrated circuit furthermore includes a gain medium which is suitable for absorbing the pumping radiation and emitting laser radiation and a waveguide which is suitable for feeding the pumping radiation to the gain medium The photonic integrated circuit furthermore includes a first and a second resonator mirror of which one is arranged in a light path between the pumping laser diode and the gain medium and another is arranged on a side of the gain medium which faces away from the pumping laser diode An optical resonator is formed between the first and the second resonator mirror

### CROSS-REFERENCE TO RELATED APPLICATIONS

The present application is a national stage entry from International Application No. PCT/EP2023/075698, filed on Sep. 18, 2023, published as International Publication No. WO 2024/068344 A1 on Apr. 4, 2024, and claims the priority of German patent application No. 10 2022 125 325.2 dated Sep. 30, 2022, the disclosures of all of which are hereby incorporated by reference in their entireties.

### BACKGROUND

Semiconductor lasers based on the GaN material system or the InGaAlP material system, for example, are widely used as a narrow-band light source. In general, the search is on for concepts with which laser beams can be generated in a large wavelength range and with a larger spectral bandwidth.

The present invention is based on the task of providing an improved photonic integrated circuit and an improved optoelectronic device.

### SUMMARY

According to embodiments, the problem is solved by the subject matter of the independent patent application. Advantageous further developments are defined in the dependent patent claims.

According to embodiments, a photonic integrated circuit comprises a pump laser diode configured to emit pump radiation and a gain medium configured to absorb the pump radiation and emit laser radiation.

The photonic integrated circuit further comprises a waveguide configured to supply the pump radiation to the gain medium. The photonic integrated circuit further comprises a first and a second resonator mirror, one of which is arranged in a light path between the pump laser diode and the gain medium and the other one of which is arranged on a side of the gain medium facing away from the pump laser diode, wherein an optical resonator is formed between the first and the second resonator mirror.

For example, the pump laser diode may comprise an active region containing a GaN-containing semiconductor material.

For example, the gain medium is a crystalline lithium fluoride-containing gain medium. According to embodiments, the gain medium contains LiLuF₄ or LiRhF₄.

The gain medium can be doped with rare earth ions.

According to embodiments, the gain medium is embedded in a cladding material with a lower refractive index than the refractive index of the gain medium. The cladding material is arranged on side surfaces of the gain medium parallel to a direction in which the optical resonator extends.

For example, the cladding material is made of the material of the gain medium and is undoped. According to embodiments, the cladding material can also be adjacent to the waveguide.

The photonic integrated circuit may further comprise a ring resonator arranged in a light path downstream of the gain medium and configured to filter the laser radiation emitted by the gain medium.

The photonic integrated circuit may further include an active optical element capable of altering an emission spectrum of the photonic integrated circuit.

According to embodiments, the gain medium is divided into at least a first and a second section, which are arranged along a direction intersecting a direction of the pump radiation. In this way, the photonic integrated circuit can be particularly compact.

A material of the first section can be different from a material of the second section. For example, the materials of the first and second sections can be selected in such a way, that laser radiation with slightly different wavelengths is emitted by the two sections. In this way, speckles can be avoided or suppressed.

The photonic integrated circuit may further comprise a mirror configured to direct laser radiation emitted from the first section into the second section.

According to further embodiments, a photonic integrated circuit comprises a pump laser diode configured to emit pump radiation, a first gain medium configured to absorb the pump radiation and to emit first laser radiation, a first and a second resonator mirror, one of which is arranged in a light path between the pump laser diode and the first gain medium and the other one of which is arranged on a side of the first gain medium facing away from the pump laser diode, wherein a first optical resonator is formed between the first and second resonator mirrors. The photonic integrated circuit further comprises a second optical resonator having associated first and second resonator mirrors and a second gain medium arranged in the second optical resonator and configured to absorb the pump radiation and emit second laser radiation having a wavelength different from the wavelength of the first laser radiation. The photonic integrated circuit further comprises an optical switch configured to selectively supply pump radiation to the first or the second optical resonator.

For example, the first and second gain medium may comprise an identical base material with a different dopant in each case.

According to embodiments, the base material may contain crystalline lithium fluoride.

An optoelectronic device according to embodiments comprises the photonic integrated circuit as described above.

The optoelectronic device can, for example, be selected from a sensor and AR/VR data glasses.

### BRIEF DESCRIPTION OF THE DRAWINGS

The accompanying drawings serve to provide an understanding of embodiments of the invention. The drawings illustrate embodiments and, together with the description, serve to explain them. Further examples of embodiments and many of the intended advantages are directly apparent from the following detailed description. The elements and structures shown in the drawings are not necessarily shown to scale in relation to one another. Identical reference signs refer to identical or corresponding elements and structures.

FIG. 1 shows a schematic cross-sectional view of a photonic integrated circuit according to embodiments.

FIG. 2A shows a schematic cross-sectional view of a photonic integrated circuit according to further embodiments.

FIG. 2B shows a schematic top view of a photonic integrated circuit according to embodiments.

FIG. 3 shows a gain medium embedded in a cladding material.

FIG. 4A shows a schematic top view of a photonic integrated circuit according to further embodiments.

FIG. 4B shows a schematic cross-sectional view of the photonic integrated circuit shown in FIG. 4A.

FIG. 5A shows a schematic cross-sectional view of a photonic integrated circuit according to embodiments.

FIG. 5B shows a schematic top view of a photonic integrated circuit according to embodiments.

FIG. 5C shows a cross-section of a first and a second gain medium embedded in a cladding material.

FIG. 6A shows a schematic top view of a photonic integrated circuit according to embodiments.

FIG. 6B shows a cross-sectional view of the photonic integrated circuit shown in FIG. 6A.

FIG. 7 shows a schematic view of an optoelectronic device according to embodiments.

### DETAILED DESCRIPTION

In the following detailed description, reference is made to the accompanying drawings, which form part of the disclosure and in which specific embodiments are shown for illustrative purposes. In this context, directional terminology such as “top”, “bottom”, “front”, “back”, “above”, “on”, “in front of”, “behind”, “front”, “rear”, etc. is referred to the orientation of the figures just described. Since the components of the embodiments can be positioned in different orientations, the directional terminology is for explanatory purposes only and is in no way limiting.

The description of the embodiments is not limiting, as other embodiments exist and structural or logical changes can be made without departing from the scope defined by the claims. In particular, elements of embodiments described below may be combined with elements of other described embodiments, unless the context indicates other-wise.

The terms “wafer” or “semiconductor substrate” used in the following description may include any semiconductor-based structure having a semiconductor surface. Wafer and structure are to be understood as including doped and undoped semiconductors, epitaxial semiconductor layers, optionally supported by a base substrate, and further semi-conductor structures. For example, a layer of a first semiconductor material can be grown on a growth substrate of a second semiconductor material, for example a GaAs substrate, a GaN substrate or a Si substrate, or of an insulating material, for example on a sapphire substrate.

Depending on the intended use, the semiconductor can be based on a direct or indirect semiconductor material. Examples of semiconductor materials particularly suitable for generating electromagnetic radiation include, in particular, nitride semiconductor compounds which can be used to generate ultraviolet, blue or longer wavelength light, such as GaN, InGaN, AlN, AlGaN, AlGaInN, AlGaInBN, phosphide semiconductor compounds that can generate green or longer wavelength light, such as GaASP, AlGaInP, GaP, AlGaP, as well as other semiconductor materials such as GaAs, AlGaAs, InGaAs, AlInGaAs, SiC, ZnSe, Zno, Ga₂O₃, diamond, hexagonal BN and combinations of the aforementioned materials. The stoichiometric ratio of the compound semiconductor materials can vary. Other examples of semiconductor materials may include silicon, silicon-germanium and germanium. In the context of the present description, the term “semiconductor” also includes organic semiconductor materials.

The term “substrate” generally includes insulating, conductive or semiconductor substrates.

The terms “lateral” and “horizontal” as used in this description are intended to describe an orientation or alignment that is substantially parallel to a first surface of a substrate or semiconductor body. This can be, for example, the surface of a wafer or a die.

The horizontal direction can, for example, lie in a plane perpendicular to a growth direction when layers are growing. The term “vertical” as used in this description is intended to describe an orientation that is substantially perpendicular to the first surface of a substrate or semiconductor body. The vertical direction may, for example, correspond to a growth direction during the growth of layers.

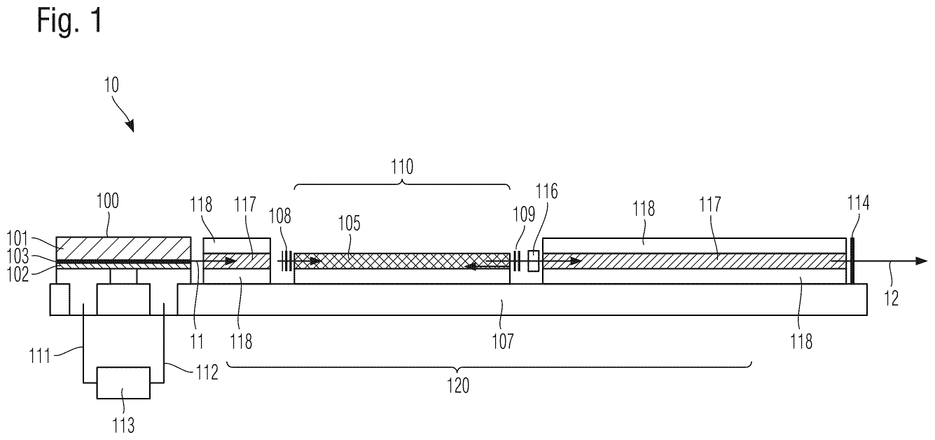

FIG. 1 shows a schematic cross-sectional view of a photonic integrated circuit 10 according to embodiments. The photonic integrated circuit or laser device 10 comprises a pump laser diode 100 having an active region 103. According to embodiments, the active region 103 comprises a GaN-containing semiconductor material. According to further embodiments, the active region may also comprise one or more other semiconductor materials other than GaN. Specific examples are mentioned above. The pump laser diode 100 is configured to emit pump radiation 11. The photonic integrated circuit 10 further comprises a gain medium 105 suitable for absorbing the pump radiation 11 and emitting laser radiation 12. For example, the gain medium 105 may comprise lithium fluoride. Furthermore, the photonic integrated circuit 10 comprises a first and a second resonator mirror 108, 109, one of which is arranged in a light path between the pump laser diode 100 and the gain medium 105. A further resonator mirror 109 is arranged on a side of the gain medium 105 facing away from the pump laser diode 100. An optical resonator 110 is formed between the first and second resonator mirrors 108, 109.

The term “pump laser diode” as used in the context of the present disclosure can include both edge-emitting and, for example, surface-emitting semiconductor lasers with a vertical cavity (“VCSEL”, “Vertical Cavity Surface Emitting Laser”) . The term “pump laser diode” can include a single diode element or an arrangement of individual diode elements. As shown in FIG. 1, the pump laser diode 100 may comprise a first semiconductor layer 101 of a first conductivity type, for example n-conductive, and a second semiconductor layer 102 of a second conductivity type, for example p-conductive. The active region 103 is arranged between the first and second semiconductor layers 101, 102.

For example, an active region can be arranged between the first and second semiconductor layer. The active region may comprise a pn junction, a double heterostructure, a single quantum well structure (SQW) or a multiple quantum well structure (MQW) for generating radiation. The term “quantum well structure” has no meaning with regard to the dimensionality of the quantization. It therefore includes quantum wells, quantum wires and quantum dots as well as any combination of these layers.

For example, to manufacture the pump laser diode 100, the first semiconductor layer 101 can first be grown over a suitable growth substrate, followed by the active region 103 and the second semiconductor layer 102. The pump laser diode 100 is then applied to the components of the photonic integrated circuit 10 as a so-called flip chip, so that the second semiconductor layer 102 faces, for example, a carrier 107 or substrate of the photonic integrated circuit 110, and the first semiconductor layer 101 forms part of a surface of the photonic integrated circuit 110. According to FIG. 1, the pump laser diode 100 is designed as an edge-emitting laser. However, it can also be designed in any other way, and electromagnetic radiation can also be emitted via a main surface of the pump laser diode.

A first connection line 111 can be electrically connected to the first semiconductor layer 101. A second connection line 112 can be electrically connected to the second semiconductor layer 102. The first and second connection lines 111, 112 are electrically connected, for example, to a driver circuit 113 for operating the pump laser diode 100.

The first and second semiconductor layers 101, 102 can contain GaN, for example. The active region 103 contains, for example, a GaN-containing semiconductor material and is suitable, for example, for emitting electromagnetic radiation with a wavelength of less than 600 or 560 nm.

The gain medium 105 is suitable for absorbing the pump radiation and emitting laser radiation with a longer wavelength. The gain medium 105 may, for example, contain crystalline lithium fluoride. The crystalline lithium fluoride-containing gain medium 105 may, for example, be a crystalline medium having a perovskite crystal lattice. For example, the gain medium may include LiLuF₄ or LiRhF₄. The gain medium may be doped with rare earth elements. According to embodiments, the gain medium can be doped with terbium or praseodymium.

When terbium is used as the doping material, for example, a wavelength range of the emitted laser radiation 12 of 540 nm to 590 nm can result. Using praseodymium as the doping material can, for example, result in a wavelength range of the emitted laser radiation of 600 nm to 650 nm.

For example, as shown in FIG. 1, the pump radiation 11 can be fed to a waveguide 117, via which the pump radiation 11 is fed to the gain medium 105. Furthermore, the laser radiation 12 emitted by the gain medium 105 can be fed to a further waveguide 117. For example, a waveguide material may comprise LiNDO₃, SiN, Al₂N₃ or Al₂O₃.

The first and second resonator mirrors 108, 109 may each be wavelength selective mirrors suitable for reflecting electromagnetic radiation in a predetermined wavelength range. A reflection-reducing coating 114 may be disposed on an exit side of the waveguide 117.

For example, the first and/or the second resonator mirror 108, 109 may reflect the incident electromagnetic radiation to a large degree (for example >90%) and contain non-conductive layers. The first and/or second resonator mirror may be formed by a sequence of very thin dielectric layers with respectively different refractive indices. For example, the layers can alternately have a high refractive index (n>n0) and a low refractive index (n<n0) and be formed as Bragg mirrors, where n0 depends on the materials used, in particular on whether the mirrors contain insulating or semiconductor layers. For example, the layer thickness can be λ/4, where λ indicates the wavelength of the light to be reflected in the respective medium. The layer seen from the incident light can have a greater layer thickness, for example 3λ/4. Due to the low layer thickness and the difference in the respective refractive indices, appropriately constructed mirrors provide a high reflectivity and are simultaneously non-conductive, for example. A Bragg mirror can comprise between 2 and 50 reflective layers, for example. A typical layer thickness of the individual layers can be around 30 to 90 nm, for example around 50 nm. The layer stack can also contain one or two or more layers that are thicker than about 180 nm, for example thicker than 200 nm.

The laser device 10 shown in FIG. 1 is a photonic integrated circuit in which the individual components are arranged, for example, on a common carrier 107. For example, a material of the carrier 107 may be or comprise silicon. The photonic integrated circuit 10 shown in FIG. 1 thus represents a compact laser source which is suitable for emitting electromagnetic radiation in a wavelength range which comprises, for example, longer wavelengths than the emission wavelength of GaN and shorter wavelengths than the emission wavelength of In-GaAlP material systems.

The photonic integrated circuit 10 may further comprise an additional optical element 16, such as an active optical element 116, which may be suitable for altering an emission spectrum of the photonic integrated circuit 10. For example, the active optical element 116 may be a modulator that actively alters the emission spectrum. Furthermore, the optical elements may be mirrors that confine the light in the gain medium and improve the optical confinement. According to further embodiments, the mirrors can also be dichroic mirrors that lead to a desired emission wavelength.

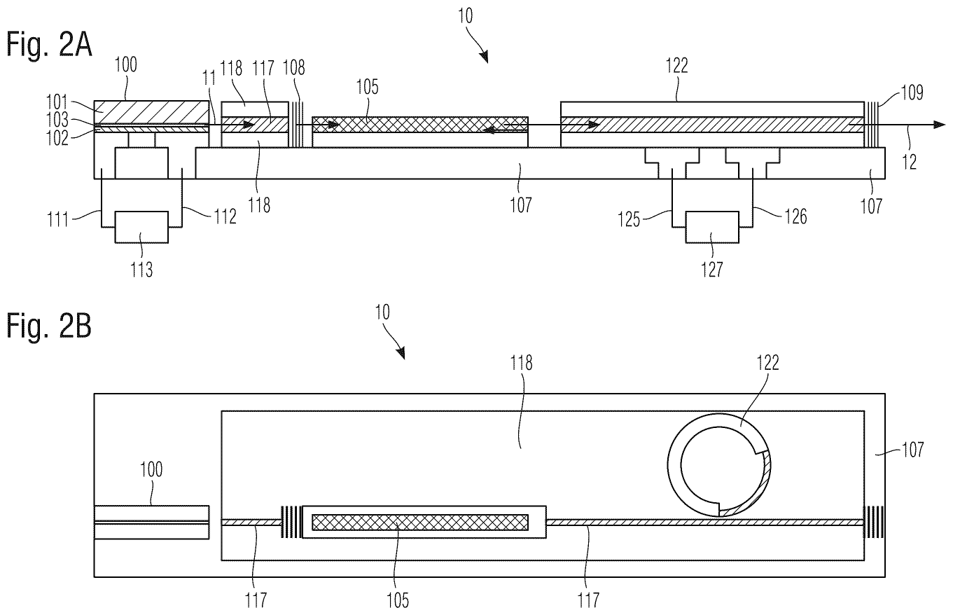

FIG. 2A shows a schematic cross-sectional view of a photonic integrated circuit 10 according to further embodiments. The photonic integrated circuit shown in FIG. 2A comprises components similar to those shown in FIG. 1. In addition, a ring resonator 122, for example a tunable ring resonator 122, is provided. The ring resonator 122 is disposed in a light path downstream of the gain medium 105. The ring resonator is suitable, for example, for filtering the laser radiation 12 emitted by the gain medium 105. The ring resonator 122 can, for example, be connected to a control device 127 via a first connecting element 125 and a second connecting element 126. The control device 127 can be set up to adjust one or more wavelengths of the laser beam 12 transmitted by the ring resonator 122. In this way, an emission wavelength of the laser beam 12 can be set by actuating the control device 127. Accordingly, for example, the emission spectrum of the photonic integrated circuit 10 can be tuned.

According to further embodiments, the ring resonator 122 may also be arranged to stabilize the emission wavelength. For example, the ring resonator 122 may be heatable. As a result, the refractive index of the material of the ring resonator may change, thereby changing a passband wavelength of the ring resonator 122. For example, in the photonic integrated circuit shown in FIG. 2A, the second resonator mirror 109 may be disposed on an exit side of the ring resonator 122. According to further embodiments, the second resonator mirror 109 may also be disposed between the gain medium 105 and the ring resonator 122.

FIG. 2B shows a top view of the photonic integrated circuit shown in FIG. 2A. The pump beam 11 emitted by the pump laser diode 100 is fed via a waveguide 117 to the gain medium 105. The laser beam 12 emitted by the gain medium 105 is then fed to the ring resonator 122 via the waveguide 117. As in the embodiment of FIG. 1, the components of the photonic integrated circuit 10 are arranged above a suitable carrier, for example a silicon substrate 107, and can form a photonic integrated circuit.

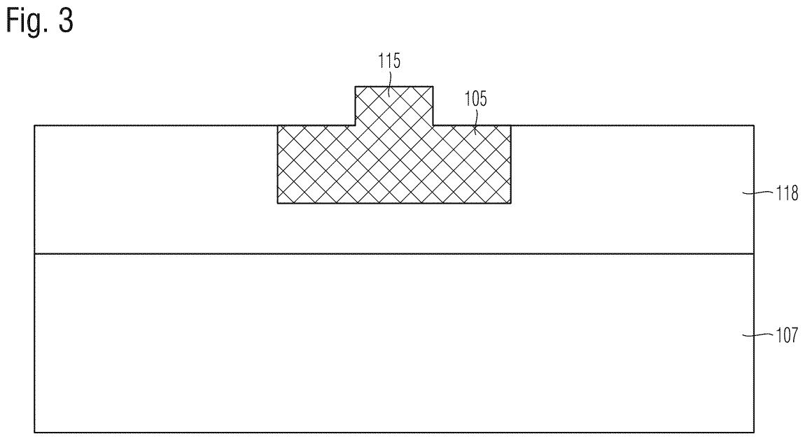

As shown in FIG. 3, according to embodiments, the gain medium 105 may be embedded in a suitable cladding material 118 and thus form a Waveguide. For example, the cladding material may be arranged on side surfaces of the gain medium parallel to an extension direction of the optical resonator and a light path. A refractive index of the cladding material is lower than the refractive index of the gain medium. For example, the cladding material can be made of the material of the gain medium and be undoped. Accordingly, in the configuration shown in FIG. 3, the gain medium 105 and the cladding material 118 are made of the same base material or consist of the same base material. The gain medium 105 is additionally doped, for example with a rare earth element. In this way, the gain medium 105 acts as a gain medium and has a higher refractive index than the surrounding cladding material 118. If the gain medium 105 and the cladding material 118 comprise the same base material, the gain medium can be produced in a simple manner, for example by implantation or diffusion. For example, the gain medium 105 can be structured to form a web 115 for mode guidance.

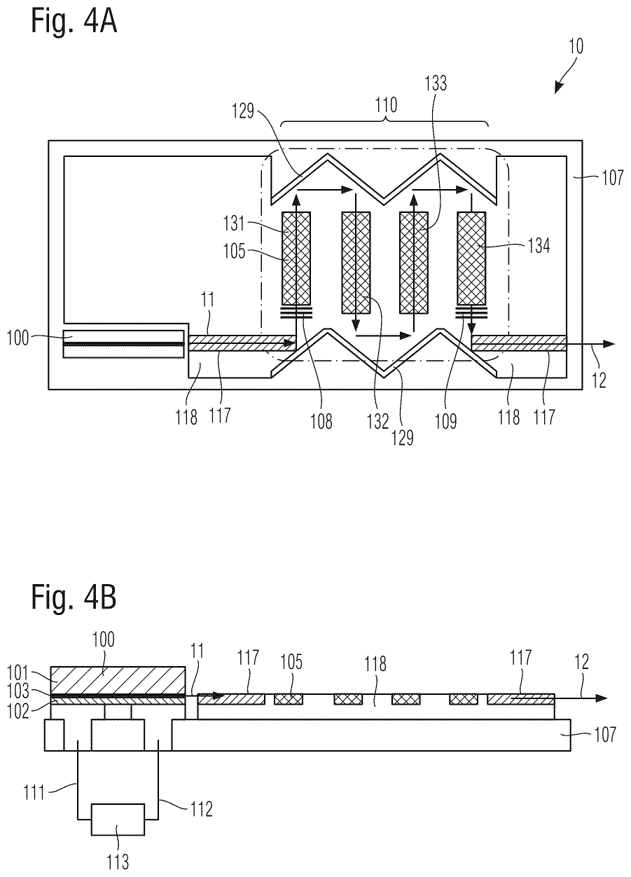

FIG. 4A shows a top view of a photonic integrated circuit 10 according to further embodiments. As shown in FIG. 4A, the gain medium 105 is divided into at least first and second sections 131, 132. The first and second sections 131, 132 are each arranged along a direction that intersects a direction of the pump radiation 11. For example, the sections of the gain medium 105 may be arranged perpendicular to an output direction of the laser beam 12. Furthermore, mirrors 129 may be arranged which are suitable for directing the pump radiation 11 onto a first section 131 of the gain medium. Further-more, mirrors 129 may be arranged to direct the laser radiation emitted by the first section into the second section of the gain medium 105.

For example, the mirrors 129 may be arranged at an angle of about 45° with respect to a direction of extension of the sections 131, 132 of the gain medium 105. For example, the mirror 129 may be a metallic mirror, a dielectric mirror, or a hybrid mirror. Further, a filter coating may be applied over the mirror 129 or the mirror 129 itself may have a wavelength filtering property so that, for example, only wavelengths to be emitted by the photonic integrated circuit 100 are selectively transmitted. Thus, as shown in FIG. 4A, the emitted laser radiation is directed from the first section 131 to the fourth section 134 of the gain medium 105. In this way, it is possible to provide an optical resonator 110 with a sufficient length and reduced footprint. As a result, the photonic integrated circuit 10 can be made more compact.

It goes without saying that sections of the gain medium 105 are not necessarily arranged parallel to each other. Furthermore, an emission direction of the laser radiation 12 may deviate from an emission direction of the pump radiation 11. For example, the various sections 131, 132, 133, 134 of the gain medium may be designed such that they each emit slightly different wavelengths. In this way, for example, speckles can be avoided. For example, different host crystals or base materials can be used in each of the different sections 131, 132, 133, 134 of the gain medium. Different dopants can also be used in the different sections. By suitably designing the mirrors used, it is possible to amplify a mixture of desired modes. In this way, it is possible to specifically amplify and decouple a defined mixture of modes and thus shape the spectrum.

FIG. 4B shows a schematic cross-sectional view of the photonic integrated circuit 10 shown in FIG. 4A. The illustration in FIG. 4B is similar to the illustration in FIG. 1. However, the waveguides 117 and the sections of the gain medium 105 are embedded in the cladding material 118, as also described with reference to FIG. 3. In particular, the gain medium 105 and the cladding material 118 may comprise the same base material, with the gain medium 105 being doped and the cladding material 118 being undoped. The photonic integrated circuit 10 shown in FIGS. 4A and 4B thus represents a photonic integrated circuit in which the gain medium is integrated into the cladding material 118. When using gain medium 105 each having a different host crystal, the cladding material 118 may correspond to one of the host crystals used and may not be doped.

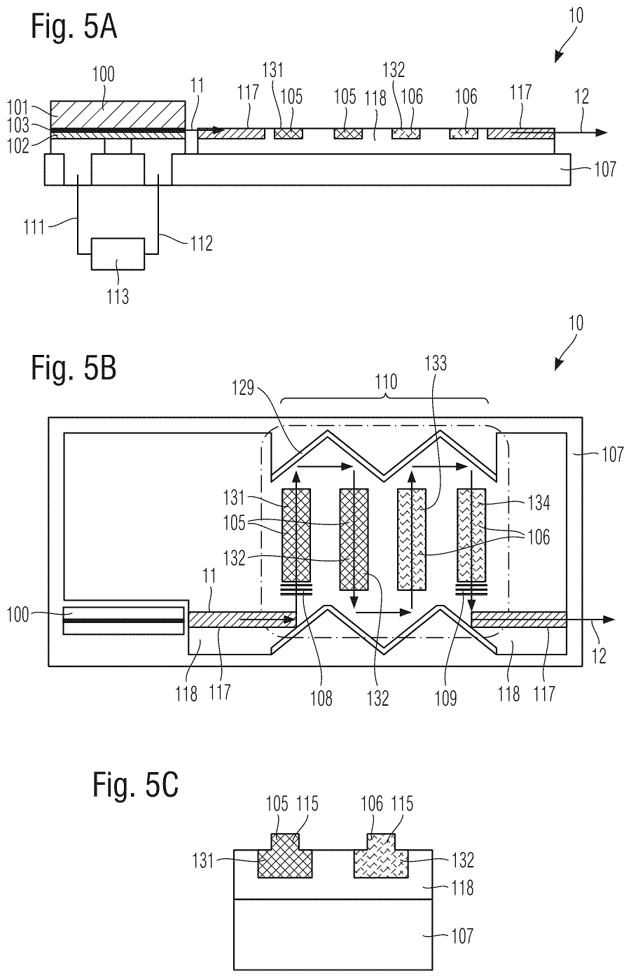

FIG. 5A shows a cross-sectional view of a photonic integrated circuit 10 according to further embodiments. In the photonic integrated circuit shown in FIG. 5A, a gain medium 105 of the first section 131 may be different from a gain medium 106 of the second section 132. The other elements of the photonic integrated circuit 10 are similar or identical to those shown in FIGS. 4A and 4B. Similar to the embodiments shown in FIGS. 4A through 4B, the first gain medium 105 and the second gain medium 106 may be embedded in a cladding material 118. For example, the first gain medium 105 may be doped with different rare earth elements than the second gain medium 106.

FIG. 5B shows a top view of the photonic integrated circuit 10. As can be seen, the first and second sections 131, 132 of the gain medium are formed with a different material or doped with a different dopant than the third and fourth sections 133, 134. The cladding material can in turn comprise the same base material and be undoped.

In this way, it is possible, for example, to generate electromagnetic radiation of different wavelengths.

FIG. 5C shows a cross-sectional view of the first and second sections 131, 132 of the gain medium. The first section 131 is formed with the first gain medium 105, the second section is formed with the second gain medium 106. Similarly as shown in FIG. 3, the second gain medium 106 is additionally embedded in the cladding material 118 and forms a web 115 for mode guidance. The first and second gain medium 105, 106 can each contain the same base material, but a different dopant in each case

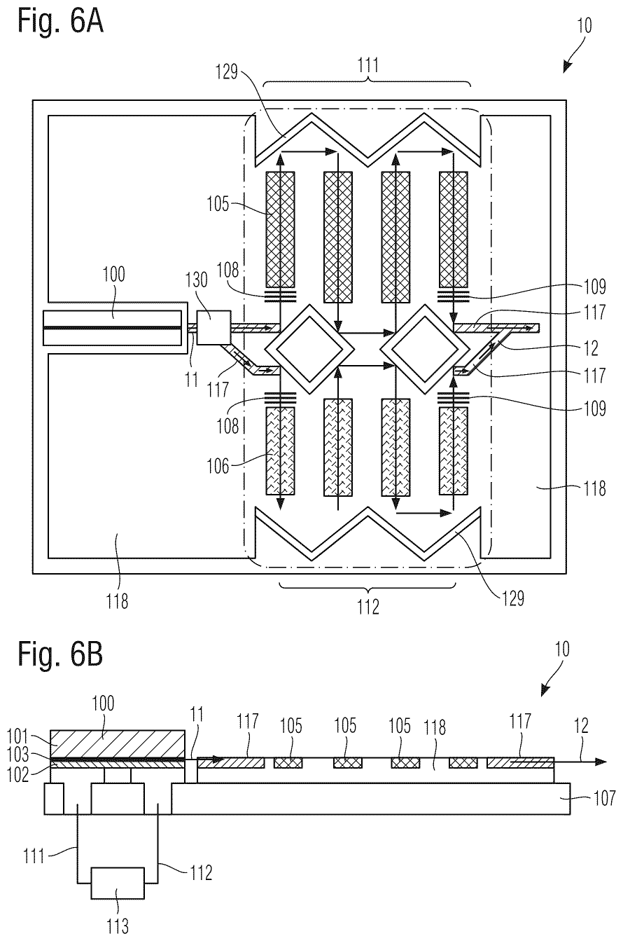

FIG. 6A shows a top view of a photonic integrated circuit 10 according to further embodiments. In addition to the components shown, for example, in FIGS. 4A and 4B, the photonic integrated circuit 10 shown in FIG. 6A comprises a second optical resonator 121 having a first and a second resonator mirror 108, 109. The second optical resonator 121 has a different configuration than the first optical resonator 111. For example, a length of the second optical resonator 121 may differ from the length of the first optical resonator 111. Furthermore, an gain medium 106 may be arranged within the second optical resonator 121 which is different from the first gain medium 105. For example, the second gain medium may comprise the same base material as the first gain medium 105. In addition, the second gain medium 106 may be doped with a different dopant.

The photonic integrated circuit 10 may further comprise an optical or photonic switch 130. The optical or photonic switch 130 may be suitable for selectively supplying pump radiation 11 to the first or second optical resonator 111, 121. For example, light with a different wavelength may be emitted through the second gain medium 106 than through the first gain medium 105. Thus, by actuating the optical switch 130, an emission wavelength of the photonic integrated circuit 10 may be switched between different wavelengths. For example, the optical switch 130 may be based on the electro-optic effect. The optical switch 130 may be integrated with the waveguide 117.

FIG. 6B shows a cross-sectional view of the photonic integrated circuit 10 shown in FIG. 6A. The waveguide 117 and the first gain medium 105 are embedded in the cladding material 118. Of course, the photonic integrated circuit 10 may include further optical resonators, each with a different gain medium or length of resonator. In this way, it is possible to switch the emission wavelength between several values.

As has been described, a very compact photonic integrated circuit with a high degree of flexibility in the design of the spectral bandwidth of the emission can be provided according to embodiments. Both photonic integrated circuits with a small spectral bandwidth and those with a large spectral bandwidth can be created. This provides a high level of monolithic integration. For example, the described photonic integrated circuits can be used in sensors, such as industrial sensors, medical sensors and others. Furthermore, they can be used in data glasses.

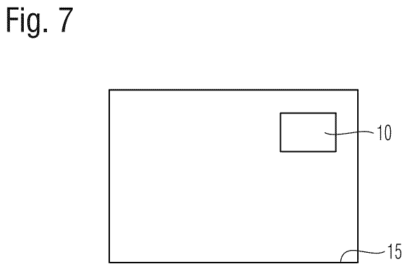

FIG. 7 shows a schematic view of an optoelectronic device 15 according to embodiments. The optoelectronic device 15 includes the described photonic integrated circuit. The optoelectronic device may be, for example, a sensor or VR/AR (“virtual reality/augmented reality”) data glasses.

Although specific embodiments have been illustrated and described herein, those skilled in the art will recognize that the specific embodiments shown and described may be replaced by a variety of alternative and/or equivalent embodiments without departing from the scope of protection of the invention. The application is intended to cover any adaptations or variations of the specific embodiments discussed herein. Therefore, the invention is limited only by the claims and their equivalents.

1. A photonic integrated circuit comprising:
a pump laser diode configured to emit pump radiation;
a gain medium configured to absorb the pump radiation and emit laser radiation;
a waveguide configured to supply the pump radiation to the gain medium; and
a first and a second resonator mirror, one of which is arranged in a light path between the pump laser diode and the gain medium and the other one of which is arranged on a side of the gain medium facing away from the pump laser diode, wherein an optical resonator is formed between the first and the second resonator mirror,
wherein the gain medium is divided into at least a first and a second section.

2. The photonic integrated circuit according to claim 1, wherein the pump laser diode comprises an active region comprising a GaN-containing semiconductor material.

3. The photonic integrated circuit according to claim 1, wherein the gain medium is a crystalline lithium fluoride-containing gain medium.

4. The photonic integrated circuit according to claim 1, wherein the gain medium comprises LiLuF₄ or LiRhF₄.

5. The photonic integrated circuit according to claim 1, wherein the gain medium is doped with rare earth ions.

6. The photonic integrated circuit according to claim 1, wherein the gain medium is embedded in a cladding material having a refractive index smaller than the refractive index of the gain medium, and the cladding material is arranged on side surfaces of the gain medium parallel to an extension direction of the optical resonator.

7. The photonic integrated circuit according to claim 6, wherein the cladding material is generated from the material of the gain medium and is undoped.

8. The photonic integrated circuit according to claim 6, wherein further the cladding material is adjacent to the waveguide.

9. The photonic integrated circuit according to claim 1, further comprising a ring resonator arranged in a light path after the gain medium and configured to filter the laser radiation emitted by the gain medium.

10. The photonic integrated circuit according to claim 1, further comprising an active optical element configured to change an emission spectrum of the photonic integrated circuit.

11. The photonic integrated circuit according to claim 1, wherein the first and the second section are arranged along a direction intersecting a direction of the pump radiation.

12. The photonic integrated circuit according to claim 11, wherein a material of the first section is different from a material of the second section.

13. The photonic integrated circuit according to claim 11, further comprising a mirror configured to direct laser radiation emitted from the first section into the second section.

14. A photonic integrated circuit comprising:
a pump laser diode configured to emit pump radiation;
a first gain medium configured to absorb the pump radiation and emit first laser radiation;
a first and a second resonator mirror one of which is arranged in a light path between the pump laser diode and the first gain medium and the other one of which is arranged on a side of the first gain medium facing away from the pump laser diode wherein a first optical resonator is formed between the first and the second resonator mirror further comprising:
a second optical resonator having an associated first and second resonator mirror and a second gain medium arranged in the second optical resonator and configured to absorb the pump radiation and emit second laser radiation having a wavelength different from the wavelength of the first laser radiation; and
an optical switch configured to selectively supply pump radiation to the first or the second optical resonator.

15. The photonic integrated circuit according to claim 14, wherein the first and second gain medium comprise an identical base material each having a different dopant.

16. The photonic integrated circuit according to claim 15, wherein the base material comprises crystalline lithium fluoride.

17. An optoelectronic device comprising the photonic integrated circuit according to claim 1.

18. The optoelectronic device according to claim 17, selected from a sensor and AR/VR data glasses.
